(19) United States
(12) Patent Application Publication
(10) Pub. No.: US 2026/0278593 A1
(43) Pub. Date: Sep. 17, 2026

(54) System, Method, and Computer Program Product for Communication Layer Management of Online Services

(71) Applicant: Visa International Service Association, San Francisco, CA (US)

(72) Inventors: Ronald Peter Van Wensveen, Farnham Common (GB); Gilles Nicolas Verstraeten, Woking (GB); Iain Christopher Royle, London (GB); Jake Jordan Butler, Berlin (DE); Mathieu André Guy Altwegg, Pfaeffikon (CH); Ranjiva Kant Prasad, Hampshire (GB); Rouven Arun Steibli, Stuttgart (DE)

(21) Appl. No.: 18/997,127

(22) PCT Filed: Jul. 25, 2023
(86) PCT No.: PCT/US23/28538

§ 371 Date: Jan. 20, 2025

Related U.S. Application Data
(60) Provisional application No. 63/391,886, filed on Jul. 25, 2022.

(51) Int. Cl. G06Q 20/38; G06Q 40/02

(52) U.S. Cl. CPC G06Q 20/3821; G06Q 40/026

(57) ABSTRACT

Provided is a system for implementing a communication interface layer for managing online services, the system including at least one processor programmed or configured to receive a request for an authentication token for access to an online service, where the request includes a user identifier, generate an authentication token associated with the user identifier, transmit the authentication token to a user device, receive a request to access the online service to perform an action associated with the account via a first function of a communication interface layer, determine that the user device is authenticated for access to the online service, and perform an action involving the online service via a second function of the communication interface layer. Methods and computer program products are also provided.

### CROSS-REFERENCE TO RELATED APPLICATIONS

This application is the U.S. National Phase of International Application No. PCT/US23/28538 filed Jul. 25, 2023, and claims priority to U.S. Provisional Patent Application No. 63/391,886 filed Jul. 25, 2022, the disclosures of which are hereby incorporated by reference in their entireties.

### BACKGROUND

### 1. Technical Field

The present disclosure relates generally to systems, devices, products, apparatus, and methods for managing online services and, in some non-limiting embodiments or aspects, to a system, method, and computer program product for implementing a communication interface layer, which may include an application programming interface, for managing online services.

### 2. Technical Considerations

An online banking system (e.g., internet banking system, web banking system, home banking system, etc.) may refer to an electronic system that enables customers of a financial institution, such as a bank, to conduct a range of financial transactions through a website operated by the website. The online banking system may connect to or be part of a core banking system operated by the financial institution to provide access to services in place of traditional branch banking. More recently, mobile banking and mobile payment functions have been incorporated with online banking systems.

Mobile banking may refer to a service provided by a financial institution that allows customers of a financial institution to conduct financial transactions remotely using a mobile device, such as a smartphone or tablet. Unlike online banking, mobile banking may use software that is hosted on the mobile device, usually in the form of a software application (e.g., a mobile application), provided by the financial institution for the purpose of carrying out functions associated with mobile banking. Mobile banking may be dependent on the availability of a data connection to the mobile device.

A mobile payment service (e.g., mobile money, mobile money transfer, etc.) may refer to an electronic payment transaction service that is operated according to financial regulation and is performed via a mobile device. Instead of conducting a payment transaction with a physical item, such as cash, check, or credit card, a consumer may use a mobile device (e.g., a software application on a mobile device) to pay (e.g., during an electronic payment transaction) for goods and/or services.

However, financial institutions, such as issuers, may find it difficult to implement new mobile payment services on a timely basis into a mobile banking service, as such implementation requires large amounts of resources (e.g., network resources, software development resources, etc.) and may require reprioritization of work.

### SUMMARY

Accordingly, provided are improved systems, devices, products, apparatus, and/or methods for implementing a communication interface layer for managing online services.

According to some non-limiting embodiments or aspects, provided is a method implementing a communication interface layer for managing online services, comprising: receiving, with at least one processor, a request for an authorization token for access to an online service associated with a transaction service provider system, wherein the request comprises an user identifier associated with an account provided by an issuer; generating, with at least one processor, an authentication token associated with the user identifier, wherein the authorization token is configured to stop functioning after a time period; transmitting, with at least one processor, the authorization token to a user device; receiving, with at least one processor, a request to access the online service associated with the account via a first function of a transaction service provider communication interface layer from the user device; determining, with at least one processor, that the user device is authenticated for access to the online service associated with the transaction service provider system; and performing, with at least one processor, an action involving the online service associated with the transaction service provider system via a second function of the transaction service provider communication interface layer.

According to some non-limiting embodiments or aspects, provided is a system for implementing a communication interface layer for managing online services, the system comprising at least one processor programmed or configured to: receive a request for an authorization token for access to an online service associated with a transaction service provider system, wherein the request comprises an user identifier associated with an account provided by an issuer; generate an authentication token associated with the user identifier, wherein the authorization token is configured to stop functioning after a time period; transmit the authorization token to a user device; receive a request to access the online service associated with the account via a first function of a transaction service provider communication interface layer from the user device; determine that the user device is authenticated for access to the online service associated with the transaction service provider system; and perform an action involving the online service associated with the transaction service provider system via a second function of the transaction service provider communication interface layer.

According to some non-limiting embodiments or aspects, provided is a computer program product for implementing a communication interface layer for managing online services, the computer program product comprising at least one non-transitory computer readable medium comprising one or more instructions which, when executed, cause at least one processor to: receive a request for an authorization token for access to an online service associated with a transaction service provider system, wherein the request comprises an user identifier associated with an account provided by an issuer; generate an authentication token associated with the user identifier, wherein the authorization token is configured to stop functioning after a time period; transmit the authorization token to a user device; receive a request to access the online service associated with the account via a first function of a transaction service provider communication interface layer from the user device; determine that the user device is authenticated for access to the online service associated with the transaction service provider system; and perform an action involving the online service associated with the transaction service provider system via a second function of the transaction service provider communication interface layer.

Further non-limiting embodiments or aspects are set forth in the following numbered clauses:
Clause 1: A computer-implemented method for implementing a communication interface layer for managing online services, comprising: receiving, with at least one processor, a request for an authorization token for access to an online service associated with a transaction service provider system, wherein the request comprises an user identifier associated with an account provided by an issuer; generating, with at least one processor, an authentication token associated with the user identifier, wherein the authorization token is configured to stop functioning after a time period; transmitting, with at least one processor, the authorization token to a user device; receiving, with at least one processor, a request to access the online service associated with the account via a first function of a transaction service provider communication interface layer from the user device; determining, with at least one processor, that the user device is authenticated for access to the online service associated with the transaction service provider system; and performing, with at least one processor, an action involving the online service associated with the transaction service provider system via a second function of the transaction service provider communication interface layer.
Clause 2: The computer implemented method of clause 1, further comprising: providing a web-based user interface to the user device for accessing one or more functions of the transaction service provider communication interface layer from via the web-based user interface.
Clause 3: The computer implemented method of clause 1 or clause 2, further comprising: receiving a request to onboard an account for access to the online service associated with a transaction service provider system, wherein the request comprises the user identifier associated with the account provided by the issuer and an account identifier of the account; and storing the user identifier associated with the account provided by the issuer and the account identifier of the account in a data structure.
Clause 4: The computer implemented method of any of clauses 1-3, wherein determining that the user device is authenticated for access to the online service associated with the transaction service provider system comprises: comparing data associated with the authorization token to the user identifier associated with the account provided by the issuer or the account identifier of the account prior to expiration of time period.
Clause 5: The computer implemented method of any of clauses 1-4, wherein performing the action involving the online service associated with the transaction service provider system via the second function of the transaction service provider communication interface layer comprises: performing the action involving the online service associated with the transaction service provider system via the second function of the transaction service provider communication interface layer independent of the user device communicating with an issuer system associated with the issuer.
Clause 6: The computer implemented method of any of clauses 1-5, wherein performing the action involving the online service associated with the transaction service provider system via the second function of the transaction service provider communication interface layer comprises: receiving an initial message from the online service associated with the transaction service provider system via the second function of the transaction service provider communication interface layer; and providing a response message to the online service associated with the transaction service provider system via the second function of the transaction service provider communication interface layer based on the initial message, wherein the response message is configured to cause the online service associated with the transaction service provider system to execute a function of the online service.
Clause 7: The computer implemented method of any of clauses 1-6, wherein the transaction service provider communication interface layer comprises an application programming interface (API) configured to execute calls between a system that operates the online service and the user device.
Clause 8: A system for implementing a communication interface layer for managing online services, the system comprising at least one processor programmed or configured to: receive a request for an authorization token for access to an online service associated with a transaction service provider system, wherein the request comprises an user identifier associated with an account provided by an issuer; generate an authentication token associated with the user identifier, wherein the authorization token is configured to stop functioning after a time period; transmit the authorization token to a user device; receive a request to access the online service associated with the account via a first function of a transaction service provider communication interface layer from the user device; determine that the user device is authenticated for access to the online service associated with the transaction service provider system; and perform an action involving the online service associated with the transaction service provider system via a second function of the transaction service provider communication interface layer.
Clause 9: The system of clause 8, wherein the at least one processor is further programmed or configured to: provide a web-based user interface to the user device for accessing one or more functions of the transaction service provider communication interface layer from via the web-based user interface.
Clause 10: The system of clause 8 or clause 9, wherein the at least one processor is further programmed or configured to: receive a request to onboard an account for access to the online service associated with a transaction service provider system, wherein the request comprises the user identifier associated with the account provided by the issuer and an account identifier of the account; and store the user identifier associated with the account provided by the issuer and the account identifier of the account in a data structure.
Clause 11: The system of any of clauses 8-10, wherein, when determining that the user device is authenticated for access to the online service associated with the transaction service provider system, the at least one processor is programmed or configured to: compare data associated with the authorization token to the user identifier associated with the account provided by the issuer or the account identifier of the account prior to expiration of time period.
Clause 12: The system of any of clauses 8-11, wherein, when performing the action involving the online service associated with the transaction service provider system via the second function of the transaction service provider communication interface layer, the at least one processor is programmed or configured to: perform the action involving the online service associated with the transaction service provider system via the second function of the transaction service provider communication interface layer independent of the user device communicating with an issuer system associated with the issuer.
Clause 13: The system of any of clauses 8-12, wherein, when performing the action involving the online service associated with the transaction service provider system via the second function of the transaction service provider communication interface layer, the at least one processor is programmed or configured to: receive an initial message from the online service associated with the transaction service provider system via the second function of the transaction service provider communication interface layer; and provide a response message to the online service associated with the transaction service provider system via the second function of the transaction service provider communication interface layer based on the initial message, wherein the response message is configured to cause the online service associated with the transaction service provider system to execute a function of the online service.
Clause 14: The system of any of clauses 8-13, wherein the transaction service provider communication interface layer comprises an application programming interface (API) configured to execute calls between a system that operates the online service and the user device.
Clause 15: A computer program product for implementing a communication interface layer for managing online services, the computer program product comprising at least one non-transitory computer readable medium comprising one or more instructions which, when executed, cause at least one processor to: receive a request for an authorization token for access to an online service associated with a transaction service provider system, wherein the request comprises an user identifier associated with an account provided by an issuer; generate an authentication token associated with the user identifier, wherein the authorization token is configured to stop functioning after a time period; transmit the authorization token to a user device; receive a request to access the online service associated with the account via a first function of a transaction service provider communication interface layer from the user device; determine that the user device is authenticated for access to the online service associated with the transaction service provider system; and perform an action involving the online service associated with the transaction service provider system via a second function of the transaction service provider communication interface layer.
Clause 16: The computer program product of clause 15, wherein the one or more instructions further cause the at least one processor to: provide a web-based user interface to the user device for accessing one or more functions of the transaction service provider communication interface layer from via the web-based user interface.
Clause 17: The computer program product of clause 15 or clause 16, wherein the one or more instructions further cause the at least one processor to: receive a request to onboard an account for access to the online service associated with a transaction service provider system, wherein the request comprises the user identifier associated with the account provided by the issuer and an account identifier of the account; and store the user identifier associated with the account provided by the issuer and the account identifier of the account in a data structure.
Clause 18: The computer program product of any of clauses 15-17, wherein, when determining that the user device is authenticated for access to the online service associated with the transaction service provider system, the one or more instructions cause the at least one processor to: compare data associated with the authorization token to the user identifier associated with the account provided by the issuer or the account identifier of the account prior to expiration of time period.
Clause 19: The computer program product of any of clauses 15-18, wherein, when performing the action involving the online service associated with the transaction service provider system via the second function of the transaction service provider communication interface layer, the one or more instructions cause the at least one processor to: perform the action involving the online service associated with the transaction service provider system via the second function of the transaction service provider communication interface layer independent of the user device communicating with an issuer system associated with the issuer.
Clause 20: The computer program product of any of clauses 15-19, wherein, when performing the action involving the online service associated with the transaction service provider system via the second function of the transaction service provider communication interface layer, the one or more instructions cause the at least one processor to: receive an initial message from the online service associated with the transaction service provider system via the second function of the transaction service provider communication interface layer; and provide a response message to the online service associated with the transaction service provider system via the second function of the transaction service provider communication interface layer based on the initial message, wherein the response message is configured to cause the online service associated with the transaction service provider system to execute a function of the online service.
Clause 21: The computer program product of any of clauses 15-20, wherein the transaction service provider communication interface layer comprises an application programming interface (API) configured to execute calls between a system that operates the online service and the user device.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the present disclosure. As used in the specification and the claims, the singular form of “a,” “an,” and “the” include plural referents unless the context clearly dictates otherwise.

### BRIEF DESCRIPTION OF THE DRAWINGS

Additional advantages and details of the present disclosure are explained in greater detail below with reference to the exemplary embodiments that are illustrated in the accompanying figures, in which:

FIG. 1 is a diagram of a non-limiting embodiment or aspect of an environment in which systems, devices, products, apparatus, and/or methods, described herein, may be implemented according to the principles of the present disclosure;

FIG. 2 is a diagram of a non-limiting embodiment or aspect of components of one or more devices of FIG. 1;

FIG. 3 is a flowchart of a non-limiting embodiment or aspect of a process for implementing a communication interface layer for managing online services; and

FIGS. 4A-4D are diagrams of an implementation of a non-limiting embodiment or aspect of a process for implementing a communication interface layer for managing online services.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosure as it is oriented in the drawing figures. However, it is to be understood that the disclosure may assume various alternative variations and step sequences, except where expressly specified to the contrary. It is also to be understood that the specific devices and processes illustrated in the attached drawings, and described in the following specification, are simply exemplary embodiments or aspects of the disclosure. Hence, specific dimensions and other physical characteristics related to the embodiments or aspects of the embodiments disclosed herein are not to be considered as limiting unless otherwise indicated.

No aspect, component, element, structure, act, step, function, instruction, and/or the like used herein should be construed as critical or essential unless explicitly described as such. In addition, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. The phrase “based on” may also mean “in response to” and be indicative of a condition for automatically triggering a specified operation of an electronic device (e.g., a processor, a computing device, etc.) as appropriately referred to herein.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some non-limiting embodiments, a message may refer to a network packet (e.g., a data packet and/or the like) that includes data.

As used herein, the terms “issuer,” “issuer institution,” “issuer bank,” or “payment device issuer,” may refer to one or more entities that provide accounts to individuals (e.g., users, customers, and/or the like) for conducting payment transactions, such as credit payment transactions and/or debit payment transactions. For example, an issuer institution may provide an account identifier, such as a primary account number (PAN), to a customer that uniquely identifies one or more accounts associated with that customer. In some non-limiting embodiments, an issuer may be associated with a bank identification number (BIN) that uniquely identifies the issuer institution. As used herein, the term “issuer system” may refer to one or more computer systems operated by or on behalf of an issuer, such as a server executing one or more software applications. For example, an issuer system may include one or more authorization servers for authorizing a transaction.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa@, MasterCard®, American Express®, or any other entity that processes transactions. As used herein, the term “transaction service provider system” may refer to one or more computer systems operated by or on behalf of a transaction service provider, such as a transaction service provider system executing one or more software applications. A transaction service provider system may include one or more processors and, in some non-limiting embodiments or aspects, may be operated by or on behalf of a transaction service provider.

As used herein, the term “merchant” may refer to one or more entities (e.g., operators of retail businesses) that provide goods and/or services, and/or access to goods and/or services, to a user (e.g., a customer, a consumer, and/or the like) based on a transaction, such as a payment transaction. As used herein, the term “merchant system” may refer to one or more computer systems operated by or on behalf of a merchant, such as a server executing one or more software applications. As used herein, the term “product” may refer to one or more goods and/or services offered by a merchant.

As used herein, the term “acquirer” may refer to an entity licensed by the transaction service provider and approved by the transaction service provider to originate transactions (e.g., payment transactions) involving a payment device associated with the transaction service provider. As used herein, the term “acquirer system” may also refer to one or more computer systems, computer devices, and/or the like operated by or on behalf of an acquirer. The transactions the acquirer may originate may include payment transactions (e.g., purchases, original credit transactions (OCTs), account funding transactions (AFTs), and/or the like). In some non-limiting embodiments, the acquirer may be authorized by the transaction service provider to assign merchant or service providers to originate transactions involving a payment device associated with the transaction service provider. The acquirer may contract with payment facilitators to enable the payment facilitators to sponsor merchants. The acquirer may monitor the compliance of the payment facilitators in accordance with regulations of the transaction service provider. The acquirer may conduct due diligence of the payment facilitators and ensure proper due diligence occurs before signing a sponsored merchant. The acquirer may be liable for all transaction service provider programs that the acquirer operates or sponsors. The acquirer may be responsible for the acts of the acquirer's payment facilitators, merchants that are sponsored by the acquirer's payment facilitators, and/or the like. In some non-limiting embodiments, an acquirer may be a financial institution, such as a bank.

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like operated by or on behalf of a payment gateway.

As used herein, the terms “client” and “client device” may refer to one or more computing devices, such as processors, storage devices, and/or similar computer components, that access a service made available by a server. In some non-limiting embodiments, a client device may include a computing device configured to communicate with one or more networks and/or facilitate transactions such as, but not limited to, one or more desktop computers, one or more portable computers (e.g., tablet computers), one or more mobile devices (e.g., cellular phones, smartphones, personal digital assistant, wearable devices, such as watches, glasses, lenses, and/or clothing, and/or the like), and/or other like devices. Moreover, the term “client” may also refer to an entity that owns, utilizes, and/or operates a client device for facilitating transactions with another entity.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “server” may refer to one or more computing devices, such as processors, storage devices, and/or similar computer components that communicate with client devices and/or other computing devices over a network, such as the Internet or private networks and, in some examples, facilitate communication among other servers and/or client devices. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices and/or components of such (e.g., processors, servers, client devices, software applications, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

Non-limiting embodiments or aspects of the present disclosure are directed to systems, methods, and computer program products for implementing a communication interface layer for managing online services. In some non-limiting embodiments or aspects, a service management system may include at least one processor programmed or configured to receive a request for an authentication token for access to an online service associated with a transaction service provider system, wherein the request comprises a user identifier associated with an account provided by an issuer; generate an authentication token associated with the user identifier, wherein the authentication token is configured to stop functioning after a time period; transmit the authentication token to a user device; receive a request to access the online service to perform an action associated with the account via a first function of a transaction service provider communication interface layer from the user device; determine that the user device is authenticated for access to the online service associated with the transaction service provider system; and perform an action involving the online service associated with the transaction service provider system via a second function of the transaction service provider communication interface layer.

In some non-limiting embodiments or aspects, the service management system is further programmed or configured to: provide a web-based user interface to the user device for accessing one or more functions of the transaction service provider communication interface layer. In some non-limiting embodiments or aspects, the service management system is further programmed or configured to: receive a request to onboard an account for access to the online service associated with a transaction service provider system, wherein the request comprises the user identifier associated with the account provided by the issuer and an account identifier of the account; and store the user identifier associated with the account provided by the issuer and the account identifier of the account in a data structure.

In some non-limiting embodiments or aspects, when determining that the user device is authenticated for access to the online service associated with the transaction service provider system, the service management system is programmed or configured to: compare data associated with the authentication token to the user identifier associated with the account provided by the issuer or the account identifier of the account prior to expiration of the time period.

In some non-limiting embodiments or aspects, when performing the action involving the online service associated with the transaction service provider system via the second function of the transaction service provider communication interface layer, the service management system is programmed or configured to: perform the action involving the online service associated with the transaction service provider system via the second function of the transaction service provider communication interface layer independent of the user device communicating with an issuer system associated with the issuer.

In some non-limiting embodiments or aspects, when performing the action involving the online service associated with the transaction service provider system via the second function of the transaction service provider communication interface layer, the service management system is programmed or configured to: receive an initial message from the online service associated with the transaction service provider system via the second function of the transaction service provider communication interface layer; and provide a response message to the online service associated with the transaction service provider system via the second function of the transaction service provider communication interface layer based on the initial message, wherein the response message is configured to cause the online service associated with the transaction service provider system to execute a function of the online service. In some non-limiting embodiments or aspects, the transaction service provider communication interface layer comprises an application programming interface (API) configured to execute calls between a system that operates the online service and the user device.

In this way, the service management system may allow for implementing aspects of mobile payment services while conserving network resources and software development resources that may otherwise be required on behalf of an issuer system. Furthermore, the transaction service provider communication interface layer (e.g., configured as a widget, such as a widget that functions based on an appropriately configured API call, a Web-view widget, etc.) allows a user of an account (e.g., a cardholder to onboard onto an online service and perform actions associated with the online service (e.g., operations that may provide configurable rules for an account) inside of an issuer environment (e.g., a software environment of an issuer that issued the account of the user).

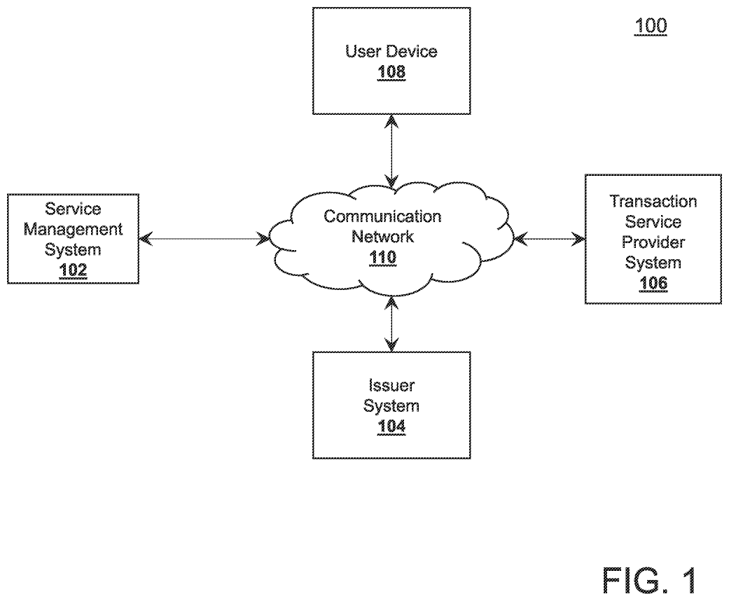

Referring now to FIG. 1, FIG. 1 is a diagram of an example environment 100 in which devices, systems, and/or methods, described herein, may be implemented. As shown in FIG. 1, environment 100 includes service management system 102, issuer system 104, transaction service provider system 106, user device 108, and communication network 110. Service management system 102, issuer system 104, transaction service provider system 106, and/or user device 108 may interconnect (e.g., establish a connection to communicate) via wired connections, wireless connections, or a combination of wired and wireless connections.

Service management system 102 may include one or more devices configured to communicate with issuer system 104, transaction service provider system 106, and/or user device 108 via communication network 110. For example, service management system 102 may include a server, a group of servers, and/or other like devices. In some non-limiting embodiments or aspects, service management system 102 may be associated with transaction service provider system 106. For example, service management system 102 may be operated by transaction service provider system 106. In another example, service management system 102 may be a component of transaction service provider system 106. In some non-limiting embodiments or aspects, service management system 102 may be in communication with a data storage device, which may be local or remote to service management system 102. In some non-limiting embodiments or aspects, service management system 102 may be capable of receiving information from, storing information in, transmitting information to, and/or searching information stored in the data storage device.

Issuer system 104 may include one or more devices configured to communicate with service management system 102, transaction service provider system 106, and/or user device 108 via communication network 110. In some non-limiting embodiments or aspects, issuer system may include a server, a group of servers, and/or other like devices. In some non-limiting embodiments or aspects, issuer system 104 is associated with an issuer. For example, issuer system 104 may be operated by an issuer.

Transaction service provider system 106 may include one or more devices configured to communicate with service management system 102, issuer system 104, and/or user device 108 via communication network 110. For example, transaction service provider system 106 may include a computing device, such as a server, a group of servers, and/or other like devices. In some non-limiting embodiments or aspects, transaction service provider system 106 may be associated with a transaction service provider system.

User device 108 may include a computing device configured to communicate with service management system 102, issuer system 104, and/or transaction service provider system 106 via communication network 110. For example, user device 108 may include a computing device, such as a desktop computer, a portable computer (e.g., tablet computer, a laptop computer, and/or the like), a mobile device (e.g., a cellular phone, a smartphone, a personal digital assistant, a wearable device, and/or the like), and/or other like devices. In some non-limiting embodiments or aspects, user device 108 may be associated with a user (e.g., an individual operating user device 108).

Communication network 110 may include one or more wired and/or wireless networks. For example, communication network 110 may include a cellular network (e.g., a long-term evolution (LTE) network, a third-generation (3G) network, a fourth-generation (4G) network, a fifth-generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN) and/or the like), a private network, an ad hoc network, an intranet, the Internet, a fiber optic-based network, a cloud computing network, and/or the like, and/or a combination of some or all of these or other types of networks.

The number and arrangement of devices and networks shown in FIG. 1 are provided as an example. There may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally or alternatively, a set of devices (e.g., one or more devices) of environment 100 may perform one or more functions described as being performed by another set of devices of environment 100.

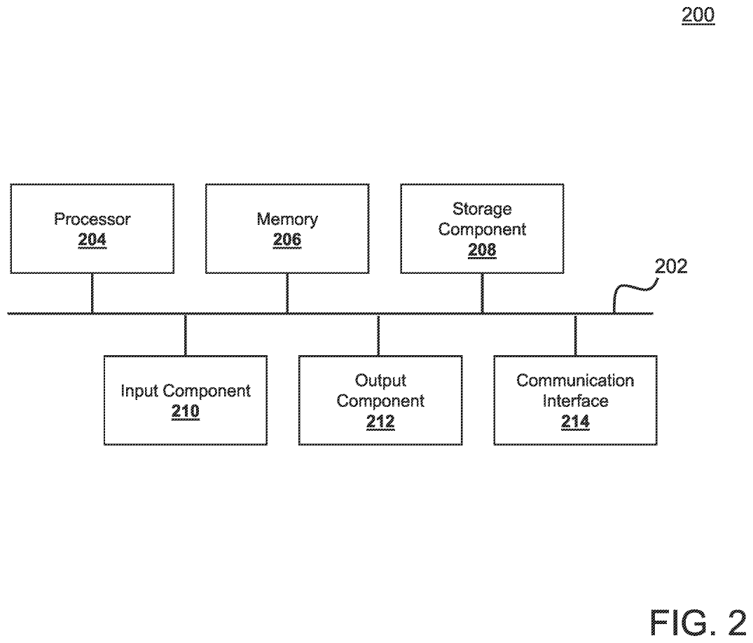

Referring now to FIG. 2, FIG. 2 is a diagram of example components of a device 200. Device 200 may correspond to service management system 102 (e.g., one or more devices of service management system 102), transaction service provider system 106 (e.g., one or more devices of transaction service provider system 106), and/or user device 108. In some non-limiting embodiments or aspects, service management system 102, transaction service provider system 106, and/or user device 108 may include at least one device 200 and/or at least one component of device 200. As shown in FIG. 2, device 200 may include bus 202, processor 204, memory 206, storage component 208, input component 210, output component 212, and communication interface 214.

Bus 202 may include a component that permits communication among the components of device 200. In some non-limiting embodiments or aspects, processor 204 may be implemented in hardware, firmware, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read-only memory (ROM), and/or another type of dynamic or static storage memory (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid-state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, etc.). Additionally or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

The number and arrangement of components shown in FIG. 2 are provided as an example. In some non-limiting embodiments, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

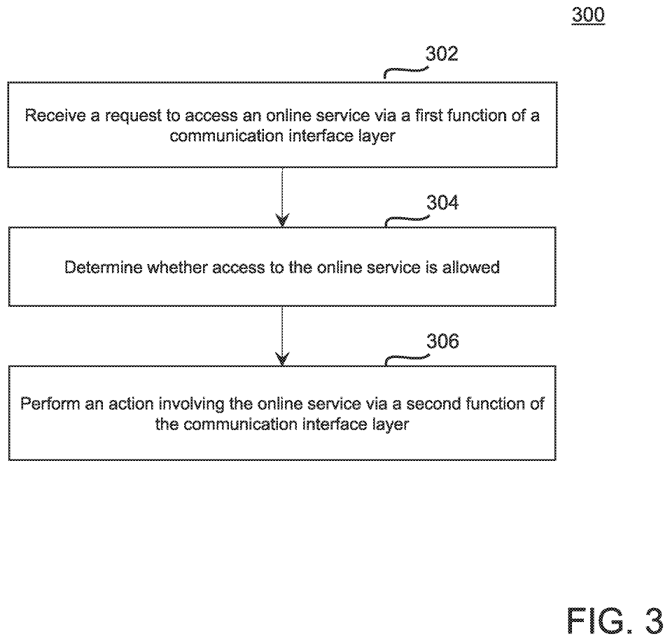

Referring now to FIG. 3, FIG. 3 is a flowchart of a non-limiting embodiment or aspect of a process 300 for implementing a communication interface layer for managing online services. In some non-limiting embodiments or aspects, one or more of the steps of process 300 may be performed (e.g., completely, partially, etc.) by service management system 102 (e.g., one or more devices of service management system 102). In some non-limiting embodiments or aspects, one or more of the steps of process 300 may be performed (e.g., completely, partially, etc.) by another device or a group of devices separate from or including service management system 102 (e.g., one or more devices of service management system 102), issuer system 104, transaction service provider system 106 (e.g., one or more devices of transaction service provider system 106), and/or user device 108.

As shown in FIG. 3, at step 302, process 300 includes receiving a request to access an online service via a first function of a communication interface layer. For example, service management system 102 may receive a request to access an online service via a first function of a communication interface layer. In some non-limiting embodiments or aspects, the first function may involve authentication and/or authorization of user device 108 (e.g., a user of user device 108). In some non-limiting embodiments or aspects, an online service may include a service that is performed through the Internet that pertains to an account. For example, an online service may include an online banking service, such as a service associated with retrieving account information from an online source of information, a service associated with setting controls on an account (e.g., an account of a user associated with user device 108 that is issued by an issuer of issuer system 104), a service associated with exchanging currency in an account, a service associated with fraud protection procedures (e.g., threshold amounts for payment transaction that cause alerts to be provided) for an account, and/or the like.

In some non-limiting embodiments or aspects, service management system 102 may receive a request for an authentication token for access to an online service associated with transaction service provider system 106. In some non-limiting embodiments, the authentication token may include an access token that includes security credentials for a session and identifies a user and/or an application (e.g., an online service). In some non-limiting embodiments or aspects, the request may include a user identifier associated with an account (e.g., a unique identifier, such as an email address, an identification number, etc.) provided by an issuer (e.g., an issuer associated with issuer system 104). Additionally or alternatively, the request may include an authentication token (e.g., an authentication token associated with the user identifier).

In some non-limiting embodiments or aspects, service management system 102 may generate an authentication token for access to an online service associated with transaction service provider system 106. For example, service management system 102 may generate the authentication token associated with a user identifier associated with an account provided by an issuer associated with issuer system 104. In some non-limiting embodiments or aspects, the authentication token is configured to stop functioning after a time period (e.g., a predetermined time period). In some non-limiting embodiments or aspects, service management system 102 may generate the authentication token based on receiving a request for an authentication token.

In some non-limiting embodiments or aspects, the communication interface layer (e.g., the transaction service provider communication interface layer) may include an application programming interface (API) configured to execute calls between a system (e.g., transaction service provider system 106) that operates the online service and user device 108 (e.g., a software application executing on user device 108). In some non-limiting embodiments, the communication interface layer may be configured as a widget that functions based on an appropriately configured application programming interface (API) call (e.g., a Web-view widget, etc.) and/or redirected URLs. In some non-limiting embodiments or aspects, the communication interface layer may include a widget that provides information that is obtained from a separately hosted webpage (e.g., a webpage that is hosted separately from a webpage hosted by an issuer system).

In some non-limiting embodiments or aspects, service management system 102 may provide a user interface to the user device for accessing one or more functions of a communication interface layer. For example, service management system 102 may provide a web-based user interface to user device 108 for accessing one or more functions of a transaction service provider communication interface layer via the web-based user interface. In some non-limiting embodiments or aspects, the web-based user interface may operate (e.g., via an API call made by) an issuer system (e.g., issuer system 104) to transaction service provider system 106. For example, a user may access the web-based user interface via an application associated with the issuer system on user device 108 (e.g., via a mobile application operated by issuer system 104 that is stored on user device 108) and the application may make communicate with transaction service provider system 106 to enable operation of one or more functions of the communication interface layer. In this way, the web-based user interface may provide for more interactivity and simpler integration between an issuer system (e.g., a mobile environment of an issuer system) and transaction service provider system 106 as compared to native API-based integration. In some non-limiting embodiments or aspects, service management system 102 may provide an update to the web-based user interface. For example, service management system 102 may provide an update to the web-based user interface based on a request received from transaction service provider system 106. In this way, service management system 102 may provide for simple upgrades (e.g., over the air upgrades) to the web-based user interface that do not require systematic integration changes from an issuer system.

In some non-limiting embodiments or aspects, service management system 102 may transmit an authentication token to user device 108. For example, service management system 102 may transmit the authentication token to user device 108 via a function of a communication interface layer (e.g., a function of a transaction service provider communication interface layer). In some non-limiting embodiments or aspects, the function of the communication interface layer may operate as part of a software application (e.g., a mobile application) stored on user device 108.

In some non-limiting embodiments or aspects, as part of a setup procedure for access to one or more online services, service management system 102 may receive a request to onboard (e.g., a request to register) an account for access to an online service associated with transaction service provider system 106. In some non-limiting embodiments or aspects, the request may include a user identifier associated with an account provided by an issuer associated with issuer system 104 and/or an account identifier of the account. In some non-limiting embodiments or aspects, service management system 102 may store the user identifier associated with the account provided by the issuer and/or the account identifier of the account in a data structure (e.g., a data structure associated with service management system 102, a data structure associated with transaction service provider system 106, etc.).

As shown in FIG. 3, at step 304, process 300 includes determining whether access to the online service is allowed. For example, service management system 102 may determine whether access to the online service is allowed. In some non-limiting embodiments or aspects, service management system 102 may determine whether user device 108 is authenticated for access to an online service associated with transaction service provider system 106. In some non-limiting embodiments or aspects, service management system 102 may determine whether access to the online service is allowed based on receiving a request to access an online service (e.g., from user device 108).

In some non-limiting embodiments or aspects, service management system 102 may compare data associated with an authentication token to a user identifier associated with the account provided by the issuer and/or the account identifier of the account to determine whether access to the online service is allowed. For example, service management system 102 may compare data associated with an authentication token to a user identifier associated with the account provided by the issuer and/or the account identifier of the account prior to expiration of a time period for the authentication token.

In some non-limiting embodiments or aspects, service management system 102 may determine whether the authentication token is active (e.g., live, functional, etc.). For example, service management system 102 may determine whether the time period, for which the authentication token is configured to stop functioning, has expired.

In some non-limiting embodiments or aspects, service management system 102 may determine that access to the online service is allowed. For example, if service management system 102 determines that the authentication token is included in a request for access and/or the authentication token is active, then service management system 102 may determine that access to the online service is allowed. Additionally or alternatively, if service management system 102 determines that data associated with an authentication token corresponds to a user identifier associated with an account (e.g., an account provided by the issuer associated with issuer system 104) and/or the account identifier of the account, then service management system 102 may determine that access to the online service is allowed. In the example above, if service management system 102 determines that the authentication token is not included in a request for access and/or the authentication token is not active, then service management system 102 may determine that access to the online service is not allowed. Additionally or alternatively, if service management system 102 determines that data associated with an authentication token does not correspond to a user identifier associated with an account (e.g., an account provided by the issuer associated with issuer system 104) and/or the account identifier of the account, then service management system 102 may determine that access to the online service is not allowed.

As shown in FIG. 3, at step 306, process 300 includes performing an action involving the online service via a second function of the communication interface layer. For example, service management system 102 may perform the action involving the online service via a second function of the communication interface layer. In some non-limiting embodiments or aspects, the second function may involve execution of an online service based on instructions received from user device 108 (e.g., a user of user device 108). In some non-limiting embodiments or aspects, the second function may involve (e.g., require) user device 108 communicating (e.g., via a software application executed on user device 108) with issuer system 104 associated with the issuer before the online service may be executed (e.g., before service management system 102 may execute the online service).

In some non-limiting embodiments or aspects, service management system 102 may perform an action involving an online service associated with transaction service provider system 106 via the second function of a transaction service provider communication interface layer. For example, service management system 102 may cause an operation to be carried out on an account (e.g., an account of a user of user device 108). In some non-limiting embodiments or aspects, service management system 102 may perform an action involving an online service associated with transaction service provider system 106 via a function (e.g., a second function) of a transaction service provider communication interface layer independent of (e.g., without) user device 108 communicating (e.g., via a software application executed on user device 108) with issuer system 104 associated with the issuer. For example, service management system 102 may cause an operation to be carried out on an account that was issued by issuer system 104 independent of user device 108 communicating with issuer system 104.

In some non-limiting embodiments or aspects, service management system 102 may receive an initial message from the online service associated with transaction service provider system 106 via the second function of the transaction service provider communication interface layer, and service management system 102 may provide a response message to the online service via the second function based on the initial message. In some non-limiting embodiments or aspects, the response message may be configured to cause the online service to execute a function (e.g., carry out an operation) of the online service.

In some non-limiting embodiments or aspects, a user associated with user device 108 may selects online services for subscription via a mobile application provided by an issuer associated with issuer system 104 and provide preferences for those services (e.g., which are issuer dependent) and issuer system 104 may transmit the selected online services and/or preferences to service management system 102 to register the user for the online services (e.g., according to the preferences). In some non-limiting embodiments or aspects, service management system 102 may provide an encrypted token (e.g., a JSON Web Encryption token) to user device 108, which includes a user identifier of the user and based on receiving a selection of an online service. In some non-limiting embodiments, the mobile application may receive a link to a web resource in a web-based user interface and the mobile application may request the web resource in the web-based user interface. In some non-limiting embodiments or aspects, the web resource may be provided by a content management system (e.g., a content management system of transaction service provider system 106). A web resource may provide a particular online service, and through the use of standard content management templates, the web resource may have a look and feel that is customized according to an issuer. In some non-limiting embodiments or aspects, the content management system may communicate with service management system 102 to receive data for fields in the standard content management templates. In some non-limiting embodiments, service management system 102 may use the encrypted token to determine what data is to be supplied for a standard content management template, given based on user preferences for an online service. In some non-limiting embodiments or aspects, service management system 102 may provide the data in a generic object to the content management system and the content management system may render the standard content management template (e.g., based on a look and feel for the issuer) and the standard content management template may be displayed in the web-based user interface.

In some non-limiting embodiments or aspects, when a selection of an operation (e.g., via a graphical user element) for an online service is received in the web-based user interface the content management system may transmit an action identifier to service management system 102, and service management system 102 may determine whether the operation can be performed with the standard content management template. If service management system 102 determines that the operation can be performed with the standard content management template, service management system 102 may contact the appropriate device or system to perform the operation for the online service. The results of the operation may be returned to the content management system, and the results of the operation may be displayed on the standard content management template, or a new standard content management template may be rendered. In some non-limiting embodiments or aspects, if a new standard content management template is to be rendered, service management system 102 may provide data in a generic object to the content management system for the a new standard content management template.

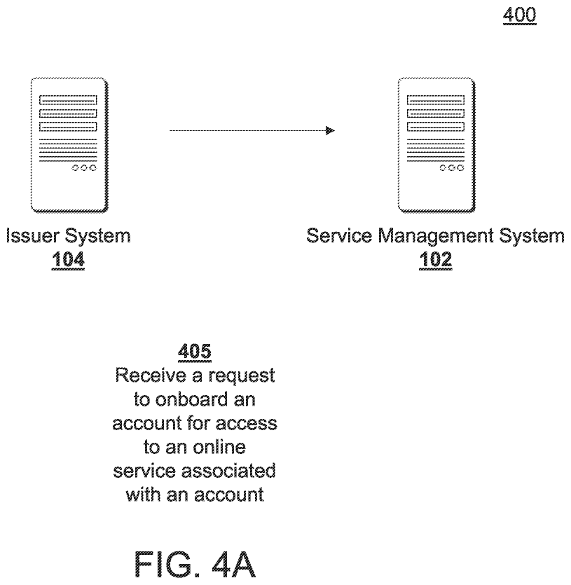

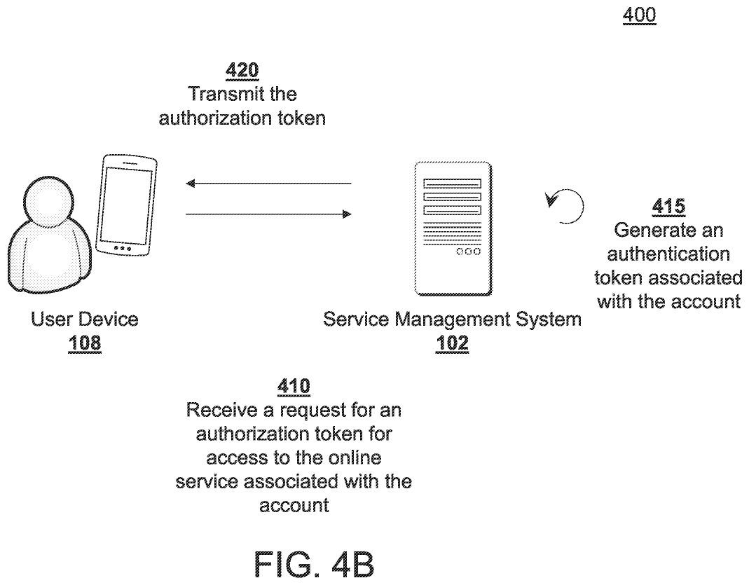

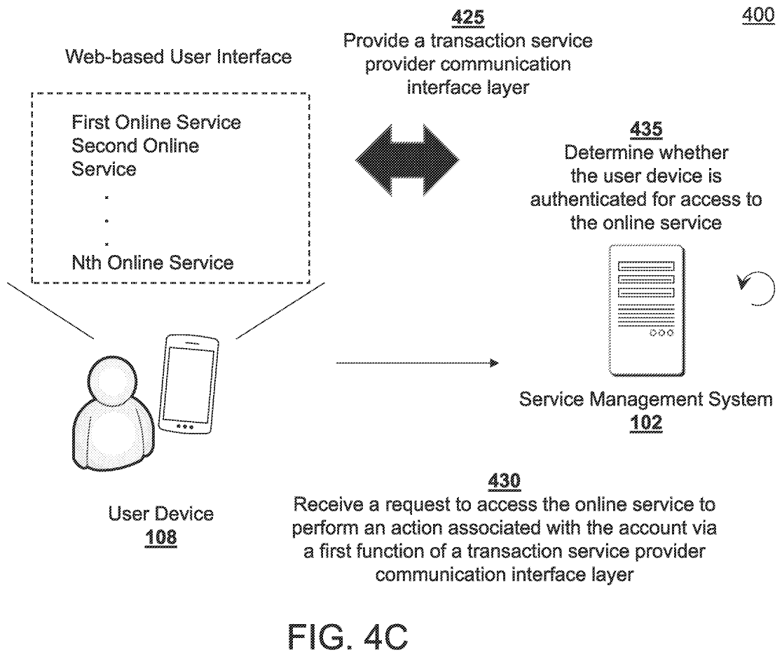

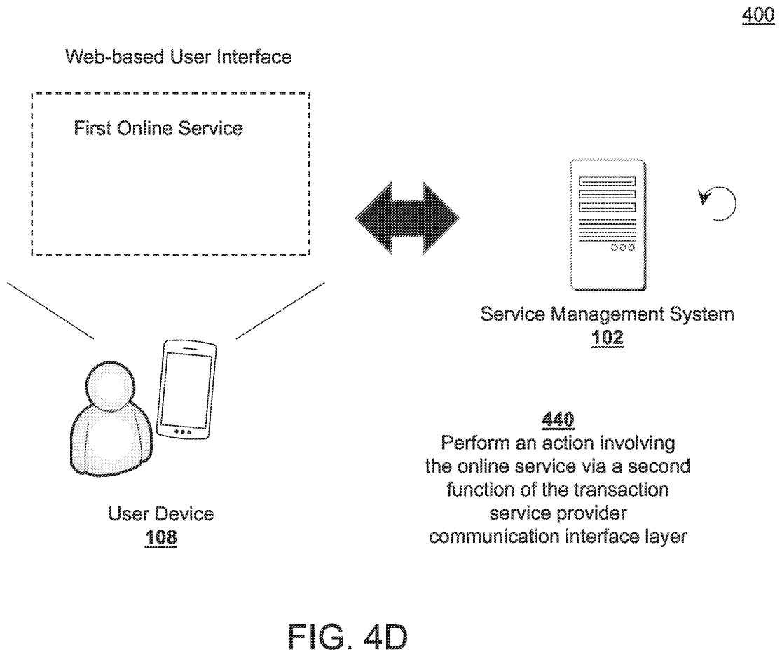

Referring now to FIGS. 4A-4D, FIGS. 4A-4D are diagrams of a non-limiting embodiment or aspect of implementation 400 relating to a process (e.g., process 300) for implementing a communication interface layer for managing online services. In some non-limiting embodiments or aspects, one or more of the steps of the process may be performed (e.g., completely, partially, etc.) by service management system 102 (e.g., one or more devices of service management system 102). In some non-limiting embodiments or aspects, one or more of the steps of the process may be performed (e.g., completely, partially, etc.) by another device or a group of devices separate from or including service management system 102 (e.g., one or more devices of service management system 102), issuer system 104, transaction service provider system 106 (e.g., one or more devices of transaction service provider system 106), and/or user device 108.

As shown by reference number 405 in FIG. 4A, service management system 102 may receive a request to onboard an account for access to an online service associated with an account. In some non-limiting embodiments or aspects, the online service is associated with transaction service provider system 106 and the request may include a user identifier associated with the account provided by the issuer and/or an account identifier of the account. In some non-limiting embodiments, or aspects service management system 102 may onboard the account for access to the online service by storing the user identifier associated with the account provided by the issuer and/or the account identifier of the account in a data structure associated with service management system 102.

As shown by reference number 410 in FIG. 4B, service management system 102 may receive a request for an authorization token for access to the online service associated with the account from user device 108. As further shown by reference number 415 in FIG. 4B, service management system 102 may generate an authentication token associated with the account. As further shown by reference number 420 in FIG. 4B, service management system 102 may transmit the authorization token to user device 108.

As shown by reference number 425 in FIG. 4C, service management system 102 may provide a transaction service provider communication interface layer to user device 108. In some non-limiting embodiments or aspects, the transaction service provider communication interface layer includes a web-based user interface that displays a plurality of online services. As further shown by reference number 430 in FIG. 4C, service management system 102 may receive a request to access the online service to perform an action associated with the account via a first function of the transaction service provider communication interface layer. For example, service management system 102 may receive the request based on a user of user device 108 selecting the online service (e.g., the first online service) associated with the account via the web-based user interface. In some non-limiting embodiments or aspects, the request may include the authentication token generated by service management system 102.

As further shown by reference number 435 in FIG. 4C, service management system 102 may determine whether user device 108 is authenticated for access to the online service. In some non-limiting embodiments or aspects, service management system 102 may determine that user device 108 is authenticated for access to the online service based on the authentication token included in the request to access the online service.

As shown by reference number 440 in FIG. 4D, service management system 102 may perform an action involving the online service via a second function of the transaction service provider communication interface layer. In some non-limiting embodiments or aspects, service management system 102 may perform the action involving the online service based on receiving instructions from user device 108 via the web-based user interface. In some non-limiting embodiments or aspects, service management system 102 may execute an operation for an online banking service (e.g., a service associated with retrieving account information from an online source of information, a service associated with setting controls on an account, a service associated with exchanging currency in an account, a service associated with fraud protection procedures for an account, etc.).

Although the present disclosure has been described in detail for the purpose of illustration based on what is currently considered to be the most practical and preferred embodiments or aspects, it is to be understood that such detail is solely for that purpose and that the present disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment. In fact, any of these features can be combined in ways not specifically recited in the claims and/or disclosed in the specification. Although each dependent claim listed below may directly depend on only one claim, the disclosure of possible implementations includes each dependent claim in combination with every other claim in the claim set.

1. A system for implementing a communication interface layer for managing online services, the system comprising:
at least one processor programmed or configured to:
receive a request for an authentication token for access to an online service associated with a transaction service provider system, wherein the request comprises a user identifier associated with an account provided by an issuer;
generate an authentication token associated with the user identifier, wherein the authentication token is configured to stop functioning after a time period;
transmit the authentication token to a user device;
receive a request to access the online service to perform an action associated with the account via a first function of a transaction service provider communication interface layer from the user device, wherein the request to access the online service comprises the authentication token;
determine that the user device is authenticated for access to the online service associated with the transaction service provider system based on the authentication token; and
perform an action involving the online service associated with the transaction service provider system via a second function of the transaction service provider communication interface layer.

2. The system of claim 1, wherein the at least one processor is further programmed or configured to:
provide a web-based user interface to the user device for accessing one or more functions of the transaction service provider communication interface layer.

3. The system of claim 1, wherein the at least one processor is further programmed or configured to:
receive a request to onboard an account for access to the online service associated with a transaction service provider system, wherein the request comprises the user identifier associated with the account provided by the issuer and an account identifier of the account; and
store the user identifier associated with the account provided by the issuer and the account identifier of the account in a data structure.

4. The system of claim 3, wherein, when determining that the user device is authenticated for access to the online service associated with the transaction service provider system, the at least one processor is programmed or configured to:
compare data associated with the authentication token to the user identifier associated with the account provided by the issuer or the account identifier of the account prior to expiration of the time period.

5. The system of claim 1, wherein, when performing the action involving the online service associated with the transaction service provider system via the second function of the transaction service provider communication interface layer, the at least one processor is programmed or configured to:
perform the action involving the online service associated with the transaction service provider system via the second function of the transaction service provider communication interface layer independent of the user device communicating with an issuer system associated with the issuer.

6. The system of claim 1, wherein, when performing the action involving the online service associated with the transaction service provider system via the second function of the transaction service provider communication interface layer, the at least one processor is programmed or configured to:
receive an initial message from the online service associated with the transaction service provider system via the second function of the transaction service provider communication interface layer; and
provide a response message to the online service associated with the transaction service provider system via the second function of the transaction service provider communication interface layer based on the initial message, wherein the response message is configured to cause the online service associated with the transaction service provider system to execute a function of the online service.

7. The system of claim 1, wherein the transaction service provider communication interface layer comprises an application programming interface (API) configured to execute calls between a system that operates the online service and the user device.

8. A computer-implemented method for implementing a communication interface layer for managing online services, comprising:
receiving, with at least one processor, a request for an authentication token for access to an online service associated with a transaction service provider system, wherein the request comprises a user identifier associated with an account provided by an issuer;
generating, with at least one processor, an authentication token associated with the user identifier, wherein the authentication token is configured to stop functioning after a time period;
transmitting, with at least one processor, the authentication token to a user device;
receiving, with at least one processor, a request to access the online service to perform an action associated with the account via a first function of a transaction service provider communication interface layer from the user device, wherein the request to access the online service comprises the authentication token;
determining, with at least one processor, that the user device is authenticated for access to the online service associated with the transaction service provider system based on the authentication token; and
performing, with at least one processor, an action involving the online service associated with the transaction service provider system via a second function of the transaction service provider communication interface layer based on determining that the user device is authenticated for access to the online service associated with the transaction service provider system.

9. The computer-implemented method of claim 8, further comprising:
providing a web-based user interface to the user device for accessing one or more functions of the transaction service provider communication interface layer.

10. The computer-implemented method of claim 8, further comprising:
receiving a request to onboard an account for access to the online service associated with a transaction service provider system, wherein the request comprises the user identifier associated with the account provided by the issuer and an account identifier of the account; and
storing the user identifier associated with the account provided by the issuer and the account identifier of the account in a data structure.

11. The computer-implemented method of claim 10, wherein determining that the user device is authenticated for access to the online service associated with the transaction service provider system comprises:
comparing data associated with the authentication token to the user identifier associated with the account provided by the issuer or the account identifier of the account prior to expiration of the time period.

12. The computer-implemented method of claim 8, wherein performing the action involving the online service associated with the transaction service provider system via the second function of the transaction service provider communication interface layer comprises:
performing the action involving the online service associated with the transaction service provider system via the second function of the transaction service provider communication interface layer independent of the user device communicating with an issuer system associated with the issuer.

13. The computer-implemented method of claim 8, wherein performing the action involving the online service associated with the transaction service provider system via the second function of the transaction service provider communication interface layer comprises:
receiving an initial message from the online service associated with the transaction service provider system via the second function of the transaction service provider communication interface layer; and
providing a response message to the online service associated with the transaction service provider system via the second function of the transaction service provider communication interface layer based on the initial message, wherein the response message is configured to cause the online service associated with the transaction service provider system to execute a function of the online service.

14. The computer-implemented method of claim 8, wherein the transaction service provider communication interface layer comprises an application programming interface (API) configured to execute calls between a system that operates the online service and the user device.

15. A computer program product for implementing a communication interface layer for managing online services, the computer program product comprising at least one non-transitory computer-readable medium including one or more instructions that, when executed by at least one processor, cause the at least one processor to:
receive a request for an authentication token for access to an online service associated with a transaction service provider system, wherein the request comprises a user identifier associated with an account provided by an issuer;
generate an authentication token associated with the user identifier, wherein the authentication token is configured to stop functioning after a time period;
transmit the authentication token to a user device;
receive a request to access the online service to perform an action associated with the account via a first function of a transaction service provider communication interface layer from the user device, wherein the request to access the online service to perform an action associated with the account comprises the authentication token;
determine whether the user device is authenticated for access to the online service associated with the transaction service provider system based on receiving the request to access the online service to perform an action associated with the account; and
perform an action involving the online service associated with the account via a second function of the transaction service provider communication interface layer.

16. The computer program product of claim 15, wherein the one or more instructions further cause the at least one processor to:
provide a web-based user interface to the user device for accessing one or more functions of the transaction service provider communication interface layer.

17. The computer program product of claim 15, wherein the one or more instructions further cause the at least one processor to:
receive a request to onboard an account for access to the online service associated with a transaction service provider system, wherein the request comprises the user identifier associated with the account provided by the issuer and an account identifier of the account; and
store the user identifier associated with the account provided by the issuer and the account identifier of the account in a data structure.

18. The computer program product of claim 17, wherein the one or more instructions that cause the at least one processor to determine that the user device is authenticated for access to the online service associated with the transaction service provider system, cause the at least one processor to:
compare data associated with the authentication token to the user identifier associated with the account provided by the issuer or the account identifier of the account prior to expiration of the time period.

19. The computer program product of claim 15, wherein the one or more instructions that cause the at least one processor to perform the action involving the online service associated with the transaction service provider system via the second function of the transaction service provider communication interface layer, cause the at least one processor to:
perform the action involving the online service associated with the transaction service provider system via the second function of the transaction service provider communication interface layer independent of the user device communicating with an issuer system associated with the issuer.

20. The computer program product of claim 15, wherein the one or more instructions that cause the at least one processor to perform the action involving the online service associated with the transaction service provider system via the second function of the transaction service provider communication interface layer, cause the at least one processor to:
receive an initial message from the online service associated with the transaction service provider system via the second function of the transaction service provider communication interface layer; and
provide a response message to the online service associated with the transaction service provider system via the second function of the transaction service provider communication interface layer based on the initial message, wherein the response message is configured to cause the online service associated with the transaction service provider system to execute a function of the online service.
